(19) United States
(12) Patent Application Publication
(10) Pub. No.: US 2005/0239021 A1
(43) Pub. Date: Oct. 27, 2005

(54) Color primed canvas

(76) Inventor: Jiangwu Song, Wuxi (CN)

Correspondence Address: IVY Y. MEI, 4848 SAN FELIPE RD., SUITE 150-313, SAN JOSE, CA, 95135, US

(21) Appl. No.: 11/011,920

(22) Filed: Dec. 14, 2004

(30) Foreign Application Priority Data
Mar. 25, 2004 (CN) 200420025759.7
Mar. 25, 2004 (CN) 200420025760.X

(51) Int. Cl. G09B 11/10

(52) U.S. Cl. 434/84

(57) ABSTRACT

The present invention overcomes the disadvantages of the technology in prior art. It provides a simple structured canvas that allows the artists to choose to apply different background colors. The present invention has advantages over the prior art. That is cost-effective and easy to use.

This invention includes coating a non-white layer (2) on the base cloth (1) or coating a white layer (3) on the base cloth (1) and coating on the white layer (3) on non-white layer (2).

### CROSS REFERENCE TO RELATED APPLICATIONS

This application claims priority from the Chinese patent application Serial No. 200420025759 filed Mar. 25, 2004 and 200420025760.x filed on Mar. 25, 2004, which documents are incorporated herein in its entirety by this reference thereto.

### TECHNICAL FIELD

This invention relates to oil painting technology in general. Specifically, this invention relates to color primed canvas for oil painters.

### BACKGROUND INFORMATION

In prior art, the traditional oil painting canvases used by artists were manufactured mainly by coating white coatings directly on the base materials. This kind of single-color canvases could not meet the needs of oil painting and water-color artists for different colors. During an oil painting process, the artists had to paint the backgrounds with necessary colors by coating on the canvas a first layer of pigments, such as oil painting pigments, water-color pigments, or propylene pigments. Such practices were not only a waste of the costly pigments and time but also not convenient.

### SUMMARY OF THE INVENTION

The present invention overcomes the disadvantages of the technology in prior art. It provides a simple structured canvas that allows the artists to choose to apply different background colors. The present invention has advantages over the prior art. That is cost-effective and easy to use.

This invention includes coating a non-white layer (2) on the base cloth (1) or coating a white layer (3) on the base cloth (1) and coating on the white layer (3) on non-white layer (2).

### BRIEF DESCRIPTION OF THE DRAWINGS

FIG. 1 is the front sectional view of the canvas according to one embodiment of the present invention; and

FIG. 2 is the front sectional view of the canvas according to one embodiment of the present invention.

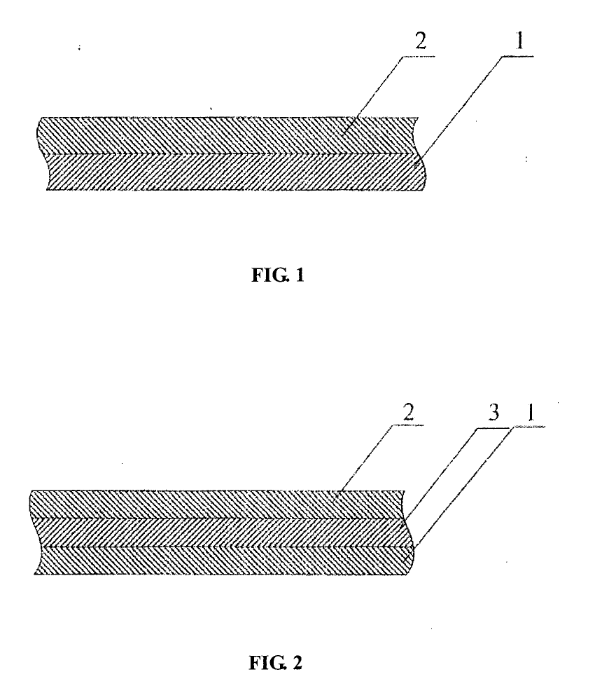

### DETAILED DESCRIPTION

The embodiments will be further illustrated below in accordance with the drawings.

### Embodiment One

One embodiment of the present invention includes the base cloth (1) of may be various kinds of cloths used as the oil-painting canvas. The base cloth (1) is directly coated with the colorful coating layer (2) with a thickness in the range of 0.1 to 2 mm. The method for applying a colorful coating layer is the same as that of applying a white layer.

The coating material containing pigments is used in the present invention, and the coating layer is provided with various colors or may be a color coating layer with uniform texture, and thereby the stretched oil-painting canvas and the plate-like oil-painting canvas of various specifications may be achieved. If metal powder (for example, gold, copper and aluminum powder) is used as the pigment, oil-painting canvas with golden and silver coating layers may be produced; and if pearl pigment is used, oil-painting canvas with pearl coating may be produced; and if charcoal powder is used, oil-painting canvas with black coating may be produced; while if other different pigments are used, oil-painting canvas with colorful coating layer and oil-painting canvas with uniform texture may be produced.

### Embodiment Two

This invention includes a base cloth (1) which may be any kind of canvas suitable for base cloths in paintings. The invention includes coating a white layer (3) on the base cloth (1) and coating on the white layer (3) on non-white layer (2). The same method is applied for both coating the white layer (3) and the non-white layer (2). The non-white layer (2) has a thickness of between 0.1 and 2 mm.

The invention applies a color-primed canvas or a multi color-coating layer with uniform texture and various other kinds of canvas for various kinds of oil-painting and water painting. Metal power, such as gold, copper or aluminum power, can also be used to produce canvas of corresponding colors. Pearl power can also be used to produce pearl-colored painting canvas. Charcoal powder can also be used to produce black canvas. Any other color can be applied to produce a color-primed canvas and a multi color-coating layer with uniform texture.

1. An oil-painting canvas with a plurality of color coating layers, comprising the base cloth (1), wherein the base cloth (1) is coated with a non-white coating layer (2), or coated with a white coating layer (3) on which a second colorful coating layer (2) is then coated.

2. The oil-painting canvas in claim 1, wherein the thickness of the color coating layer (2) is in the range of 0.1 to 2 mm.
